(19) United States
(12) Patent Application Publication
(10) Pub. No.: US 2005/0076683 A1
(43) Pub. Date: Apr. 14, 2005

(54) Multi-stage motorcycle lock

(76) Inventor: An-Hung Chen, Tainan Hsien (TW)

Correspondence Address: An-Hung Chen, P.O. Box 90, Tainan City, 704, TW

(21) Appl. No.: 10/681,941

(22) Filed: Oct. 10, 2003

(51) Int. Cl. E05B 37/02

(52) U.S. Cl. 70/28

(57) ABSTRACT

A multi-stage motorcycle lock includes a locking seat, a guide rod, a combination lock with numbers thereon, a retaining seat, a stopper, a protecting sleeve, a telescopic rod, a stud lock rod, etc. Each of plurality of eccentric holes of the combination lock is formed with a confining ring, and the locking means of the telescopic rod is eccentric. The eccentric design causes that the lock only has only correct number. The eccentric holes are rotated through 180 degrees, the locking means of the telescopic rod is stopped by the confining rings of the combination lock so that the telescopic rod can not protrude out or reduce inwards. Thereby, the effect of burglar-proof is achieved. There are two locking stages so as to have a preferred burglar-proof is achieved. The locking and unlocking of the present invention are not performed by using any key. Thus the operation is convenient.

### BACKGROUND OF THE INVENTION

1. Field of the Invention

The present invention relates to locks, and particular to a multi-stage motorcycle lock which includes a locking seat, a guide rod, a combination lock with numbers thereon, a retaining seat, a stopper, a protecting sleeve, a telescopic rod, a stud lock rod, etc. There are two locking stages so as to have a preferred burglar-proof is achieved. The locking and unlocking operations are not performed by using any key. Thus the operation is convenient.

2. Description of the Prior Art

With reference to FIG. 1, the general motorcycle lock has a key seat 11 at a front end of a hollow receiving chamber 100 of the lock cylinder 10. A pair of coupled pinholes 101, 110 are formed on the lock cylinder 10 and the lock seat 11. The two pinholes 101, 110 are aligned and then a pin 13 is inserted into the two pinholes 101 and 110. In locking, one leg 120 of a U shape stud lock rod 12 is obliquely inserted into an elliptical lock hole 102 in the lock cylinder and the buckling groove 121 of the leg 120 is coupled to a stop stud 103 at one end of the receiving chamber 100 of the lock cylinder 10. Then the stud lock rod is guided to a correct direction so that another leg 122 is inserted into a round lock hole 104 and is locked to the lock seat 11. Thereby, the U shape stud lock rod 12 cannot be pulled out from the lock cylinder 10 so as to achieve the object of locking the lock.

However, in the prior art locking structure, the buckling groove 121 of the leg 120 of the stud lock rod 9 is coupled to the stop stud 103 of the lock cylinder 10 is stopped at only one lateral side loosely. Thereby, the thief can knock the stud lock rod 12 or the lock cylinder 10 in force so as to unlock the lock seat 11. Moreover, the locking and unlocking operations must be performed by a key. This is inconvenient, especially when the key is lost.

### SUMMARY OF THE INVENTION

Accordingly, the primary object of the present invention is to provide a multi-stage motorcycle lock. The multi-stage motorcycle lock comprises the locking seat installed with a receiving chamber; a window is formed on the locking seat; a pinhole being formed near an edge of the locking seat; a positioning pin passing through the pinhole; a pivotal seat being installed at a rear end of the locking seat; scales being engraved on the locking seat; a combination lock installed in the receiving chamber of the locking seat; the combination lock being formed by a plurality of rotary blocks; each rotary block having an eccentric hole and each eccentric hole having an annular hollowed confining ring adhered to an inner wall of the eccentric hole; an outer periphery of each rotary block being formed with scales; a retaining seat being at one end portion of the locking seat; and being installed with a connecting end; a second receiving chamber being installed in the connecting end; a wall of the connecting end being formed with a pinhole; the retaining seat being formed with a via hole which is communicated to the receiving chamber; an inserting groove being formed on the retaining seat and being communicated to the via hole; a lateral wall of the retaining seat being engraved with scales; a stopper installed in the receiving chamber of the retaining seat; an interior of the stopper being formed with a via hole; a wall of the via hole being formed with a sliding groove; a telescopic rod being inserted in the retaining seat and locking seat; one end of the telescopic rod being installed with a locking means which is eccentrically arranged; a plurality of annular grooves being formed on the locking means; a guide hole being formed at an interior of the locking means; a narrow linkage being mounted between the rod body of the telescopic rod and the locking means; a buckling pin being installed near a wall surface of the rod body near the linkage; an outer periphery of the rod body being engraved with number scales; and a stud lock rod; one end thereof being a pivotal end which is pivotally installed to the pivotal seat in the locking seat and an axial hole being formed on the pivotal end 90; and another end of the stud lock rod being a buckling end which is buckled to the insertion groove of the retaining seat; a lower end of the insertion groove is formed with a narrow notch.

The various objects and advantages of the present invention will be more readily understood from the following detailed description when read in conjunction with the appended drawing.

### BRIEF DESCRIPTION OF DRAWINGS

FIG. 1 is an assembled cross section view of the prior art motorcycle key.

FIG. 2 is an exploded perspective view of the present invention.

FIG. 3 is an assembled perspective view of the present invention.

FIG. 4 is an assembled cross section view of the present invention (the lock has been locked).

FIG. 5 is a cross section view along line A-A of FIG. 4 of the present invention.

FIG. 6 is a cross section view along line B-B of FIG. 4 of the present invention.

FIG. 7 is a schematic view showing that the buckling pin of the telescopic rod is stopped in the first unlocking stage.

FIG. 8 is a cross section view along line C-C of FIG. 7.

FIG. 9 is a schematic view showing that the telescopic rod rotates to an unlock position in the first unlocking stage so that the buckling pin is stopped.

FIG. 10 is a cross section view along line D-D of FIG. 8 of the present invention.

FIG. 11 is a schematic view showing that the rotary blocks and telescopic rods of the present invention are rotated to unlock number (i. e., a schematic view of unlocking).

FIG. 12 is a schematic view showing that the rotary blocks are rotated to be opposite to set numbers so as to be buckled.

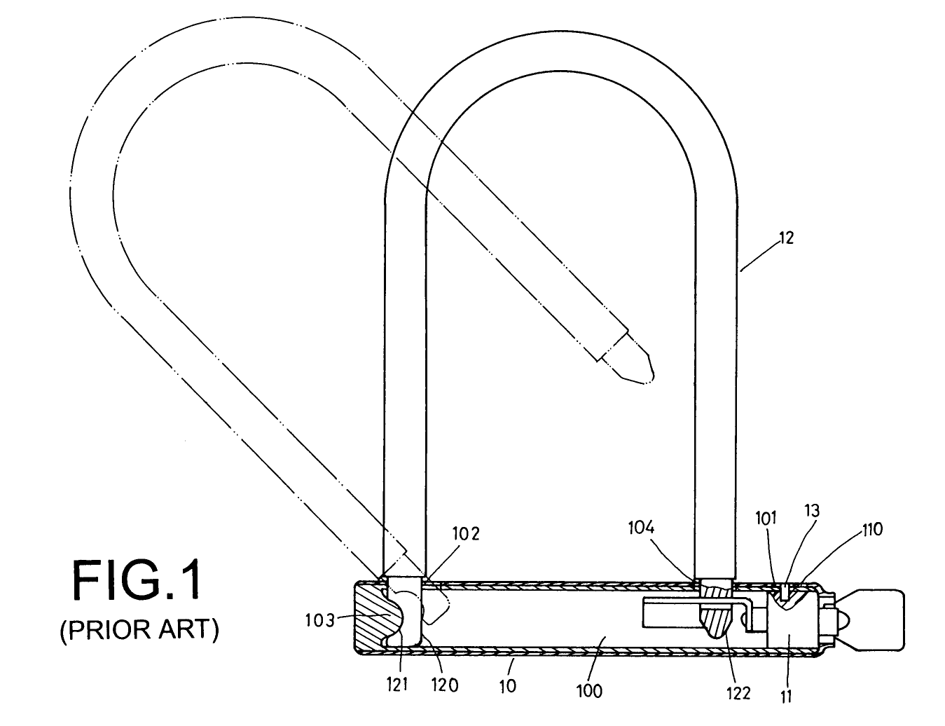

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

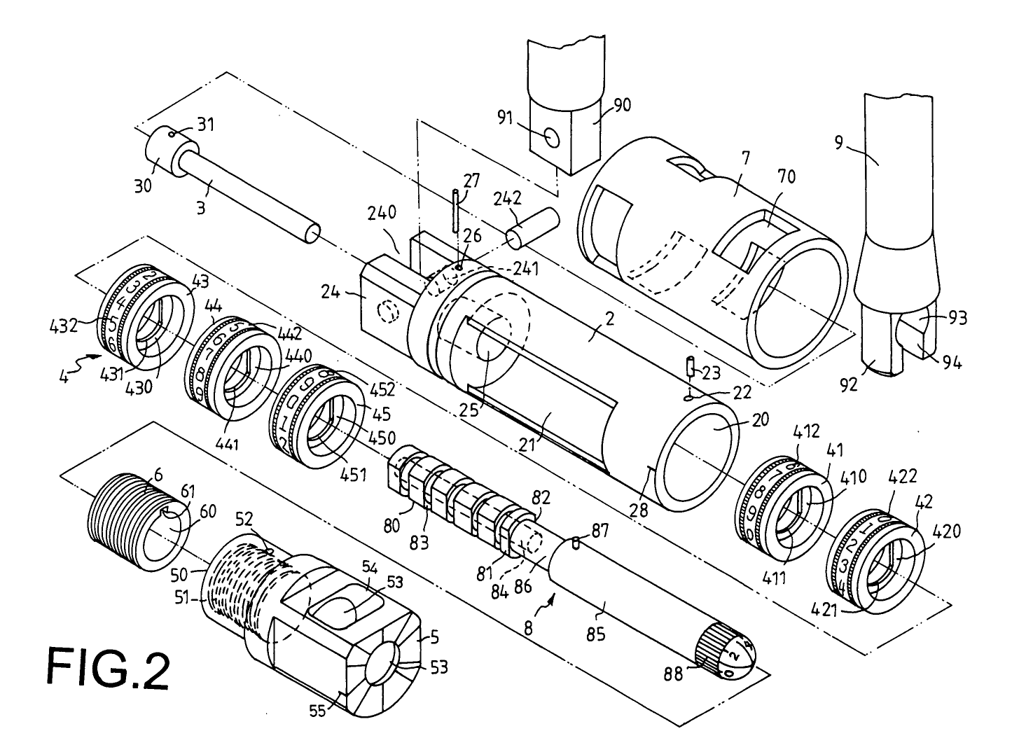

With reference to FIGS. 2, 3, and 4, the present invention includes a locking seat 2, a guide rod 3, a combination lock 4 with numbers thereon, a retaining seat 5, a stopper 6, a protecting sleeve 7, a telescopic rod 8, a stud lock rod 9, etc. The locking seat 2 is installed with a receiving chamber 20. A window is formed on the locking seat 2. A pinhole 22 is formed near an edge of the locking seat 2. A positioning pin 23 passes through the pinhole 22. A pivotal seat 24 is installed at a rear end of the locking seat 2. A slot 240 is formed in the pivotal seat 24. A wall of the pivotal seat 24 has an axial hole 241. A pivotal shaft 242 passes through the axial hole 241. The slot 240 has a via hole 25 so that the slot is communicated to the receiving chamber 20. A wall of the locking seat 2 is formed with a through hole 26. The through hole 26 is communicated to the via hole 25. A positioning pin 27 passes through the through hole 26. Scales 28 are engraved on the locking seat 2.

The guide rod 3 is firmly secured to the via hole 25 of the locking seat 2 and passes through the receiving chamber 20. One end of the guide rod 3 is a retaining block 30. A through hole 31 is formed on the retaining block 30.

The combination lock 4 is installed in the receiving chamber 20 of the locking seat 2. The combination lock 4 is formed by a first rotary block 41, a second rotary block 42, a third rotary block 43, a fourth rotary block 44 and a fifth rotary block 45. The rotary blocks 41, 42, 43, 44 and 45 are formed with respective confining rings 410, 420, 430, 440, and 450, respectively. A center of each confining ring 410, 420, 430, 440 and 450 has an eccentric hole 411, 421, 431, 441, and 451, respectively. The rotary blocks 41, 42, 43, 44 and 45 are formed with respective number scales 412, 422, 432, 442, and 452, respectively.

The retaining seat 5 is installed with a connecting end 50. A second receiving chamber 51 is installed in the connecting end 50. The receiving chamber 51 is interiorly threaded. A wall of the connecting end 50 is formed with a pinhole 52. The retaining seat 5 is formed with a via hole 53 which is communicated to the receiving chamber 51. An inserting groove 54 is formed on the retaining seat 5 and is communicated to the via hole 53. A lateral wall of the retaining seat 5 is engraved with scales 55.

The stopper 6 is installed in the receiving chamber 51 of the retaining seat 5. An outer wall of the stopper 6 is formed with outer thread. An interior of the stopper 6 is formed with a via hole 60. A wall of the via hole 60 is formed with a sliding groove 61.

The protecting sleeve 7 encloses the locking seat 2. Five penetrating holes 70 are alternatively formed on the sleeve 7.

The telescopic rod 8 is inserted in the retaining seat 5 and locking seat 2. One end of the telescopic rod 8 is installed with a locking means 80 which is eccentrically arranged. One end of the locking means is cut with a large cutting surface 81 and a small cutting surface 82 which are arranged oppositely. Five annular grooves 83 are formed on the locking means 80. A guide hole 84 is formed at an interior of the locking means 80. A narrow linkage 86 is mounted between the rod body 85 of the telescopic rod 8 and the locking means 80. A buckling pin 87 is installed near a wall surface of the rod body 85 near the linkage 86. An outer periphery of the rod body 85 is engraved with number scales 88.

The stud lock rod 9 has one end which is pivotally installed to the pivotal seat 24 in the locking seat 2 and another end of the stud lock rod 9 is buckled to the insertion groove 54 of the retaining seat 5. The stud lock rod 9 has a U shape. One end of the stud lock rod 9 is a pivotal end 90. An axial hole 91 is formed on the pivotal end 90, another end of the stud lock rod 9 is formed with a buckle end 92. An insertion groove 93 is formed on the buckling end 92. A lower end of the insertion groove 93 is formed with a narrow notch 94.

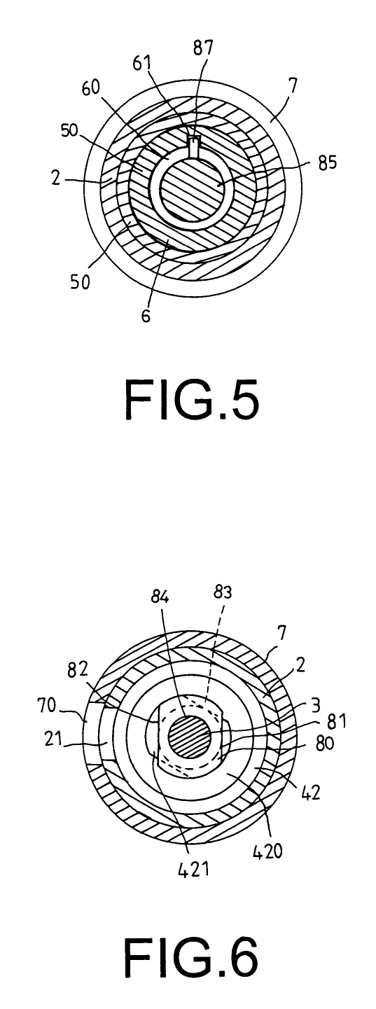

In assembly, referring to FIGS. 2, 3, and 4, the guide rod 3 inserts into the locking seat 2 from the slot 240 of the locking seat 2 so that the through hole 31 of the retaining block 30 of the guide rod 3 is aligned to the through hole 26 of the locking seat 2. Thereby, the positioning pin 27 is inserted into the through holes 26, 31 so that the guide rod 3 is fixed to the through hole 25. The body of the guide rod 3 passes into the receiving chamber 20 of the locking seat 2. Then the rotary blocks of the combination lock 4 are placed into the receiving chamber 20 of the locking seat 2 sequentially. Then the telescopic rod 8 passes into the eccentric holes 411, 421, 431, 441, and 451 of the rotary blocks of the locking seat 2. Then the guide rod 3 is inserted into the guide hole 84 of the telescopic rod 8. Moreover, the stopper 6 is assembled to the receiving chamber 51 of the retaining seat 5. Then the connecting end 50 of the retaining seat 5 is placed into the receiving chamber 20 of the locking seat 2 so that the pinhole 52 of the connecting end 50 is aligned to the pinhole 22 of the locking seat 2. Then the positioning pin 23 inserts into the pinhole 22 of the locking seat 2 and the pinhole 52 of the connecting end 50. The retaining seat 5 is retained at the end portion of the locking seat 2 and the telescopic rod 8 passes through the via hole 60 of the stopper 6 and the via hole 53 of the retaining seat 5. A front end of the telescopic rod 8 protrudes out of the retaining seat 5. The buckle pin 87 on the rod body 85 of the telescopic rod 8 is installed to the sliding groove 61 of the stopper 6 (referring to FIG. 5). Then the protecting sleeve 7 is installed to the locking seat 2 and the pivotal end 90 of the stud lock rod 9 is inserted into the slot 240 of the pivotal seat 24 of the locking seat 2 so that the stud lock rod 9 is aligned to the axial hole 241 of the pivotal seat 24. Then the pivotal shaft 242 passes into the axial holes 241, 91. Then the buckling end 92 of the stud lock rod 9 inserts into the insertion groove 54 of the retaining seat 5. Thereby, the assembly work is completed.

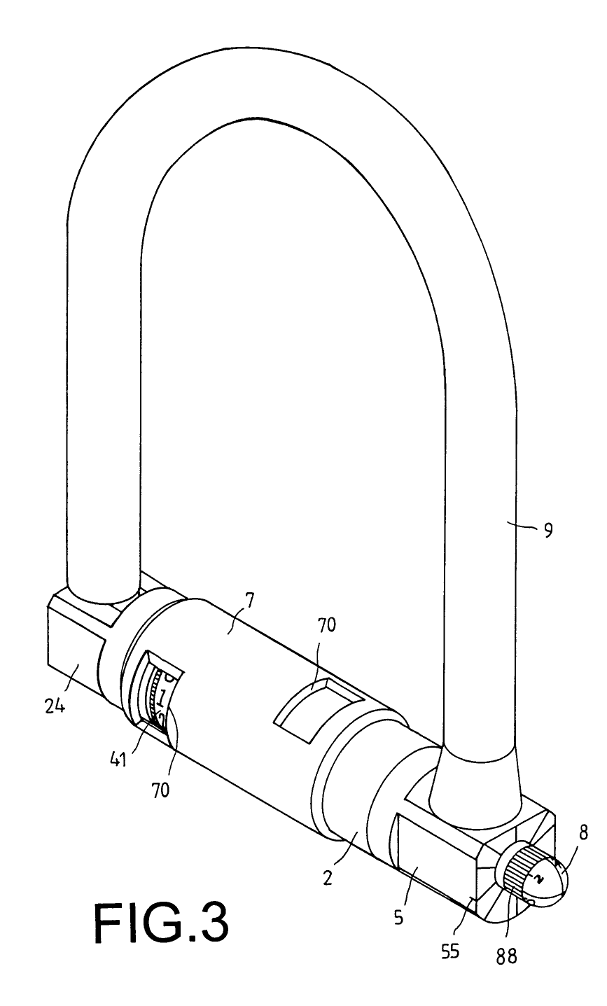

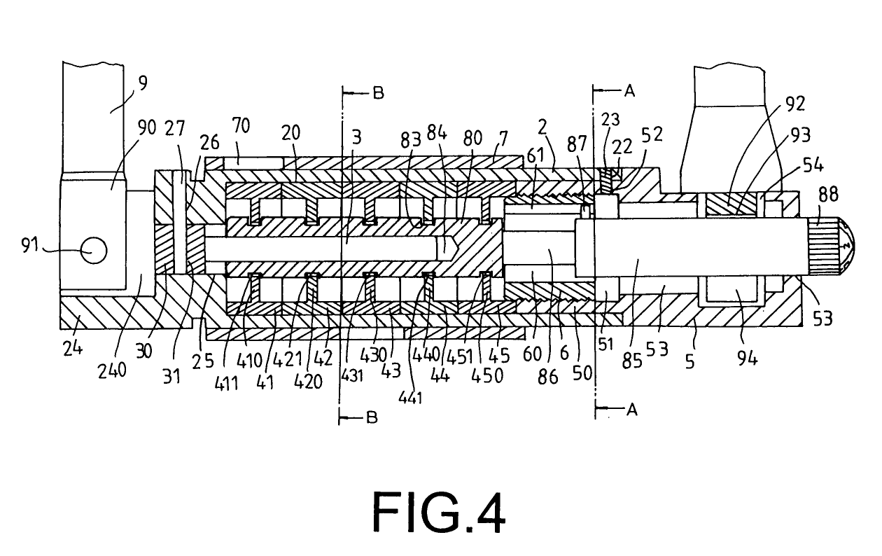

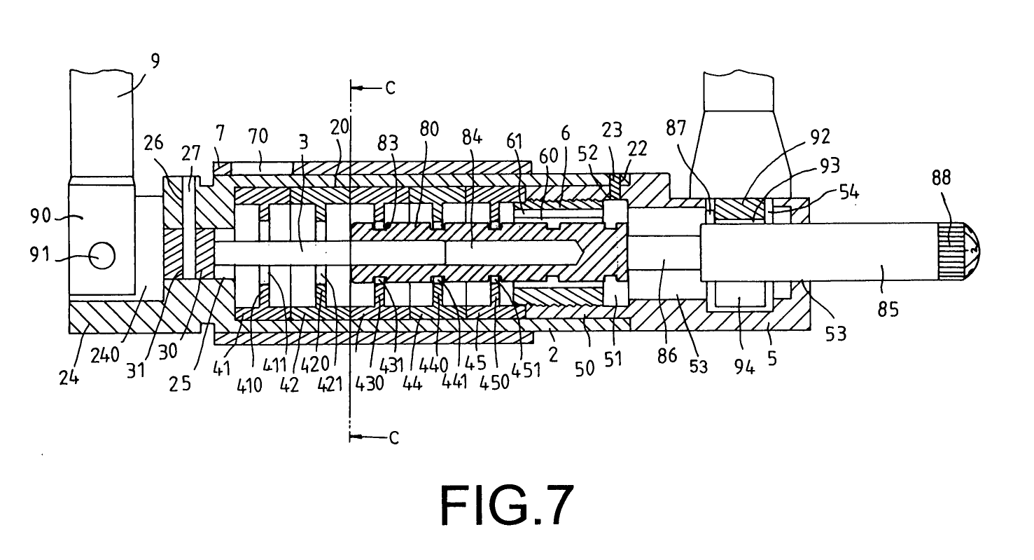

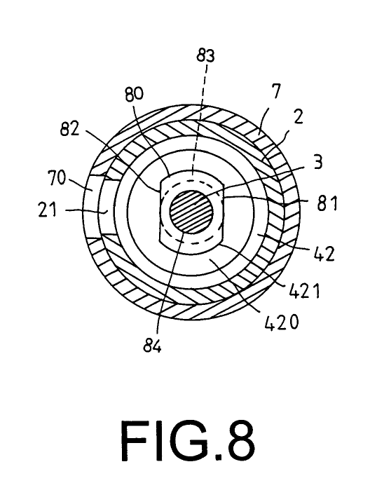

Referring to FIGS. 3 and 4, in application, the protecting sleeve 7 is rotated so that the via holes 70 of the protecting sleeve 7 are aligned to the rotary blocks in the window 21 of the locking seat 2. Then the rotary blocks 41, 42, 43, 44 and 45 are rotated sequentially so that the lock numbers of the lock are aligned to the positioning scales 28 of the locking seat 2. As a result, the eccentric holes 411, 421, 431, 441, and 451 are aligned to one another (referring to FIGS. 7 and 8) and the confining rings 410, 420, 430, 440 and 450 separate from the annular grooves 83 on the locking means 80. The telescopic rod 8 is pulled outwards so as to form a first unlocking stage.

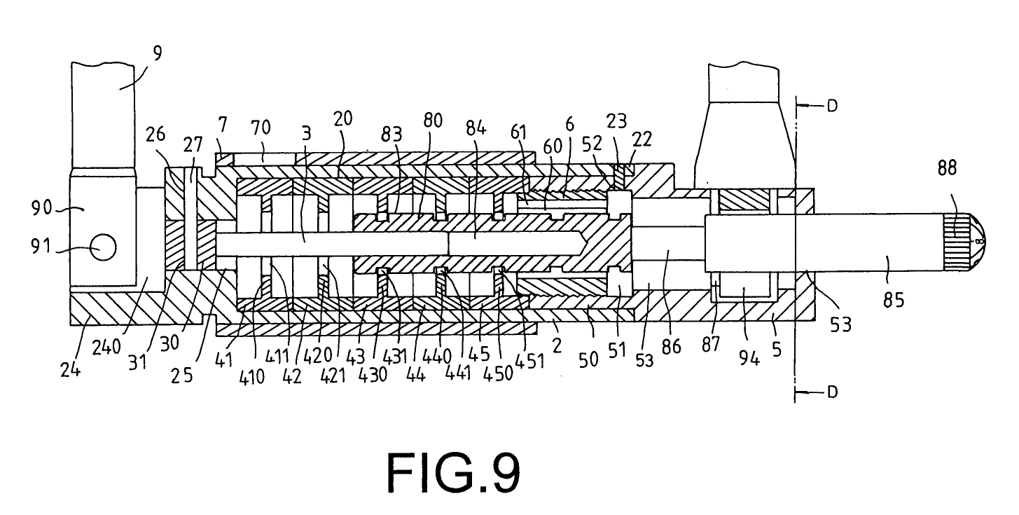

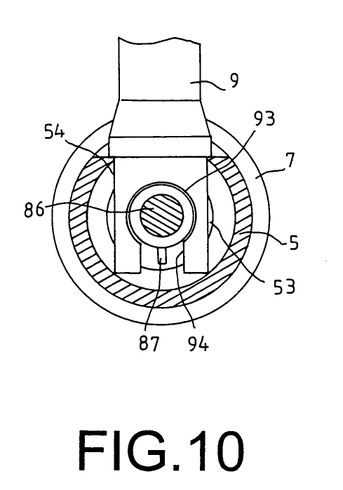

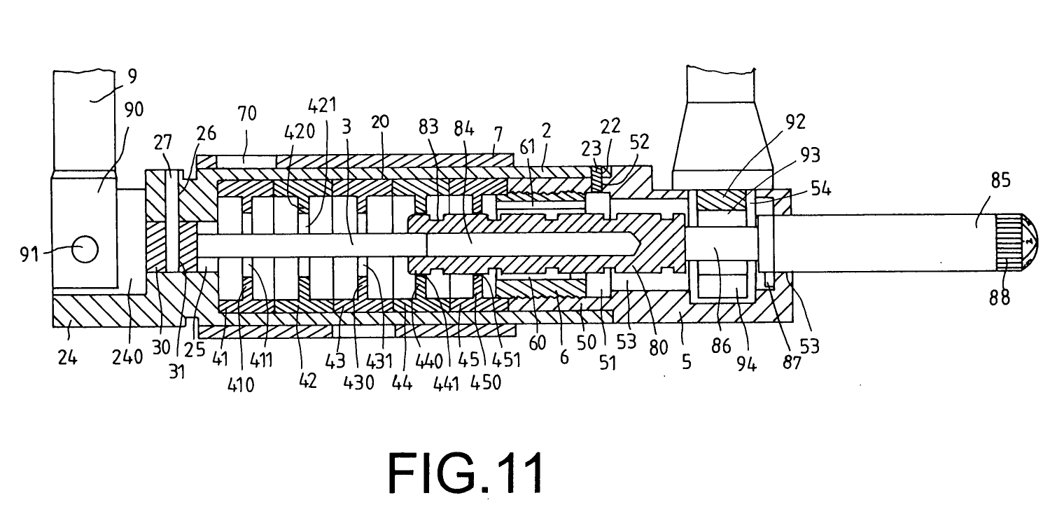

When the telescopic rod 8 is pulled until the buckling pin 87 on the rod body 85 is stopped by the buckling end 92 of the stud lock rod 9, the telescopic rod 8 is rotates so that the number scale 88 of the telescopic rod 8 is aligned to the positioning scale 55 of the retaining seat 5. Then, the buckling pin 87 on the rod body 85 of the telescopic rod 8 also rotates to be aligned to the notch 94 of the buckling end 92 of the stud lock rod 9 (referring to FIGS. 9 and 10). Then the buckling pin 87 will not be stopped by the buckling end 92. Then the telescopic rod 8 can be pulled outwards (referring to FIGS. 11). The linkage 86 on the telescopic rod 8 is positioned on the insertion groove 54 of the retaining seat 5. Thus, the rod body 85 of the telescopic rod 8 will not pass through the insertion groove 93 of the buckling end 92 of the stud lock rod 9. Thus the second unlocking stage is formed.

When the stud lock rod 9 is unlocked, the stud lock rod 9 is buckled to the rim of a wheel of a bicycle, and the buckling end 92 of the stud lock rod 9 inserts into the insertion hole 54 of the retaining seat 5, thereby, the notch 94 of the stud lock rod 9 is coupled to the linkage 85 of the telescopic rod 8 until the insertion groove 93 is aligned to the rod body 85 of the telescopic rod 8. Then the telescopic rod 8 is pushed toward the locking seat 2 and the rod body 85 of the telescopic rod 8 passes through the insertion groove 93 of the stud lock rod 9. The buckling end 92 of the stud lock rod 9 is fixed in the retaining seat 5 by the telescopic rod 8. The rotation of the telescopic rod 8 will cause that the set number is aligned to the positioning scale 55 of the retaining seat 5, while the buckling pin 87 of the telescopic rod 8 is aligned to the sliding groove 61 of the stopper 6. Then the telescopic rod 8 can be pushed inwards. Next, the rotary blocks of the combination lock 4 in the locking seat 2 can be rotated to other position so that the eccentric holes 411, 421, 431, 441, and 451 will not align to one another (referring to FIGS. 4 and 6). The confining blocks 410, 420, 430, 440 and 450 of the rotary blocks are buckled to the annular grooves 83 of the locking means 80 of the telescopic rod 8. Thereby, the operation of locking is completed.

In the present invention, the combination lock 4 is locked and then by the stopping effect of the buckling pin 87 of the telescopic rod 8, then the two locking effect is presented in the present invention. If a thief is desired to unlock the lock of the present invention, he (or she) must unlock the five numbers of the combination lock 4 and the number set in the buckling pin 87 of the telescopic rod 8 must be resolved. It is very difficult to unlock the lock of the present invention. A preferred burglar-proof effect is achieved.

When it is desired to unlock the lock, the user only needs to rotate the rotary blocks of the combination lock 4 to the unlock numbers of the lock. The eccentric holes 411, 421, 431, 441 and 451 are aligned to one another (referring to FIGS. 7 and 8), the telescopic rod 8 can be pulled outwards to a first unlocking length, and then telescopic rod 8 rotates so that the scales of the set unlock number of the buckling pin 87 is aligned to the positioning scale 55 of the retaining seat 5. Then the buckling pin 87 on the rod body 85 of the telescopic rod 8 also rotates to be in the notch 94 of the buckling end 92 of the stud lock rod 9, thereby, the buckling pin 87 will not be stopped. Then the telescopic rod 8 is pulled outwards through a second length (referring to FIG. 11). The linkage 86 of the telescopic rod 8 is positioned in the insertion groove 85 of the telescopic rod 8, while the notch 94 of the stud lock rod 9 will fall out of the linkage 86 of the telescopic rod 8. Hence, unlocking operation is completed and the operation is easily.

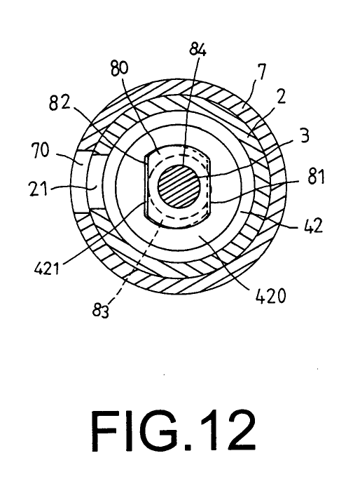

In the present invention, eccentric holes 411, 421, 431, 441 and 451 of the confining rings 410, 420, 430, 440 and 450 of the combination lock 4 are eccentric, and the locking means 80 of the telescopic rod 8 is eccentric. One side of the telescopic rod 8 has a larger cut surface and another side thereof has a smaller cut surface 82. The eccentric design causes that the lock only has only correct number. Referring to FIG. 12, the eccentric holes 411, 421, 431, 441 and 451 are rotated through 180 degrees, the locking means 80 of the telescopic rod 8 is stopped by the confining rings 410, 420, 430, 440 and 450 of the combination lock 4 so that the telescopic rod 8 can not protrude out or reduce inwards. Thereby, the effect of burglar-proof is achieved.

Advantages of the present invention is that there are two locking stages so as to have a preferred burglar-proof is achieved. The locking and unlocking of the present invention are not performed by using any key. Thus the operation is convenient.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. The multi-stage motorcycle lock comprising:
the locking seat installed with a receiving chamber; a window is formed on the locking seat; a pinhole being formed near an edge of the locking seat; a positioning pin passing through the pinhole; a pivotal seat being installed at a rear end of the locking seat; scales being engraved on the locking seat;
a combination lock installed in the receiving chamber of the locking seat; the combination lock being formed by a plurality of rotary blocks; each rotary block having an eccentric hole and each eccentric hole having an annular hollowed confining ring adhered to an inner wall of the eccentric hole; an outer periphery of each rotary block being formed with scales;
a retaining seat being at one end portion of the locking seat; and being installed with a connecting end; a second receiving chamber being installed in the connecting end; a wall of the connecting end being formed with a pinhole; the retaining seat being formed with a via hole which is communicated to the receiving chamber; an inserting groove being formed on the retaining seat and being communicated to the via hole; a lateral wall of the retaining seat being engraved with scales;
a stopper installed in the receiving chamber of the retaining seat; an interior of the stopper being formed with a via hole; a wall of the via hole being formed with a sliding groove;
a telescopic rod being inserted in the retaining seat and locking seat; one end of the telescopic rod being installed with a locking means which is eccentrically arranged; a plurality of annular grooves being formed on the locking means; a guide hole being formed at an interior of the locking means; a narrow linkage being mounted between the rod body of the telescopic rod and the locking means; a buckling pin being installed near a wall surface of the rod body; an outer periphery of the rod body being engraved with number scales; and,
a stud lock rod; one end thereof being a pivotal end which is pivotally installed to the pivotal seat in the locking seat and an axial hole being formed on the pivotal end; and another end of the stud lock rod being a buckling end which is buckled to the insertion groove of the retaining seat; a lower end of the insertion groove being formed with a narrow notch.

2. The multi-stage motorcycle lock as claimed in claim 1, wherein the receiving chamber of the retaining seat is interiorly threaded and an outer wall of the stopper is threaded.

3. The multi-stage motorcycle lock as claimed in claim 1, wherein a protecting sleeve encloses the locking seat and a plurality of via holes are alternatively formed on the protecting sleeve.

4. The multi-stage motorcycle lock as claimed in claim 1, wherein the pivotal seat of the locking seat has a cutting groove and a wall of the pivotal seat has an axial hole; a pivotal shaft passes through the axial hole for pivotally connecting the pivotal end of the stud lock rod.

5. The multi-stage motorcycle lock as claimed in claim 1, wherein one end of the locking seat is installed with a via hole which is communicated to the receiving chamber of the locking seat; a wall of the locking seat is formed with a through hole; the through hole is communicated to the via hole; a positioning pin passes through the through hole for fixing a guide rod; one end of the guide rod is a retaining block; the retaining block is installed in the via hole of the locking seat; a rod body of the guide rod passes through all the eccentric holes of all the rotary blocks of the locking seat; a guide hole is formed in an interior of the locking means of the telescopic rod; and the guide hole inserts into the guide hole.

6. The multi-stage motorcycle lock as claimed in claim 1, wherein one lateral side of the locking means of the telescopic rod has a large cutting surface and a small cutting surface is formed at an opposite side of the locking means.
